(19) United States
(12) Patent Application Publication
(10) Pub. No.: US 2005/0133582 A1
(43) Pub. Date: Jun. 23, 2005

(54) Method and apparatus for providing a trusted time stamp in an open platform

(76) Inventor: Sundeep M. Bajikar, Santa Clara, CA (US)

Correspondence Address: Cynthia T. Faatz;BLAKELY, SOKOLOFF, TAYLOR & ZAFMAN LLP, 12400 Wilshire Boulevard, Seventh Floor, Los Angeles, CA, 90025-1030, US

(21) Appl. No.: 10/744,120

(22) Filed: Dec. 22, 2003

(51) Int. Cl. G07G 1/00

(52) U.S. Cl. 235/10

(57) ABSTRACT

An approach for providing a trusted time stamp in an open platform. A trusted application initiates a request for a trusted time stamp. A time estimate is then read from a trusted source of time and an attestation process is performed to provide a signed time response. The attestation process may include providing the signed time response using a trusted platform module or other hardware token. The signed time response is provided to the requesting application to be used as a trusted time stamp.

### BACKGROUND

An embodiment of the present invention relates to the field of computing systems and, more particularly, to providing a trusted time stamp on an open platform such as, for example, a computing system.

Time stamps may be used for a variety of different types of applications. For some applications such as, for example, online banking and/or stock trading, the accuracy and reliability of a time stamp may be critical to ensuring the trustworthiness of the application.

### BRIEF DESCRIPTION OF THE DRAWINGS

Embodiments of the present invention are illustrated by way of example and not limitation in the figures of the accompanying drawings in which like references indicate similar elements, and in which:

FIG. 1 is a high-level block diagram of a computing system via which the trusted time stamp capabilities of various embodiments may be implemented.

FIG. 2 is a high-level block diagram of a computing system and associated software that may be used for various embodiments including an illustration of exemplary protected paths and partitions.

FIG. 3 is a diagram showing protected and open partitions and associated software modules for one embodiment.

FIG. 4 is a flow diagram showing a method of one embodiment for providing a trusted time stamp.

### DETAILED DESCRIPTION

A method and apparatus for providing a trusted time stamp on an open platform is described. In the following description, particular components, software modules, systems, etc. are described for purposes of illustration. It will be appreciated, however, that other embodiments are applicable to other types of components, software modules and/or systems, for example.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

For one embodiment, a trusted application initiates a request for a trusted time stamp. A time estimate is then read from a trusted source of time and an attestation process is performed to provide a signed time response. The signed time response is provided to the requesting application as a trusted time stamp.

Further details of this and other embodiments are provided in the description that follows.

Embodiments of the invention may be implemented in one or a combination of hardware, firmware, and software. Embodiments of the invention may also be implemented in whole or in part as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

In the description herein, the terms protected or trusted areas, paths and/or ports, for example, may refer to areas of a device or paths between devices that have sufficient protections associated with them to prevent access to them by most, if not all, unauthorized devices and/or software. Examples of such protections are provided in the description that follows. Further, the terms trusted software or code may refer to software that has been validated through some means to verify that it has not been altered in an unauthorized manner before execution.

The term open platform refers to a platform to which code may be written using well-known interface specifications. Examples of open platforms include most personal, workstation, server and enterprise computing systems, personal digital assistants, etc. In contrast, computing platforms such as contemporary cellular phones, GPS receivers, etc. do not extend themselves to widespread application development using well-known interface specifications. Such computing platforms may be referred to as “closed,” restricted or proprietary computing platforms.

Figur 1 is a block diagram of a computing system 100 that may advantageously implement the trusted time stamp capabilities of one or more embodiments. The computing system 100 may for example be a mobile computing system such as a notebook or laptop computer. Alternatively, the computing system 100 may be a different type of computing system such as a desktop computer, a workstation computer, a personal digital assistant, or another type of computing device. Where the computing system 100 is a mobile computing system, a battery and/or battery connector 101 may be included and coupled to the system 100 in a conventional manner to provide an alternate power source for the computing system 100 when, for example, an alternating current power source is not available or convenient.

The computing system 100 includes a central processing unit (CPU or processor) 105 coupled to a memory control hub (MCH) or other memory controller 110 via a processor bus 115, a main memory 120, which may comprise, for example, random access memory (RAM) or another type of memory, coupled to the MCH 110 over a memory bus 125, one or more trusted graphics components 130 coupled to the MCH 110 over a graphics bus 135 or integrated with another component in the system 100, and an input/output (I/O) control hub (ICH) or other I/O controller 140, which may be coupled to the MCH 110 over a bus 145. The memory controller (or MCH) 110 and the I/O controller (or ICH) 140 may be referred to collectively as the chipset.

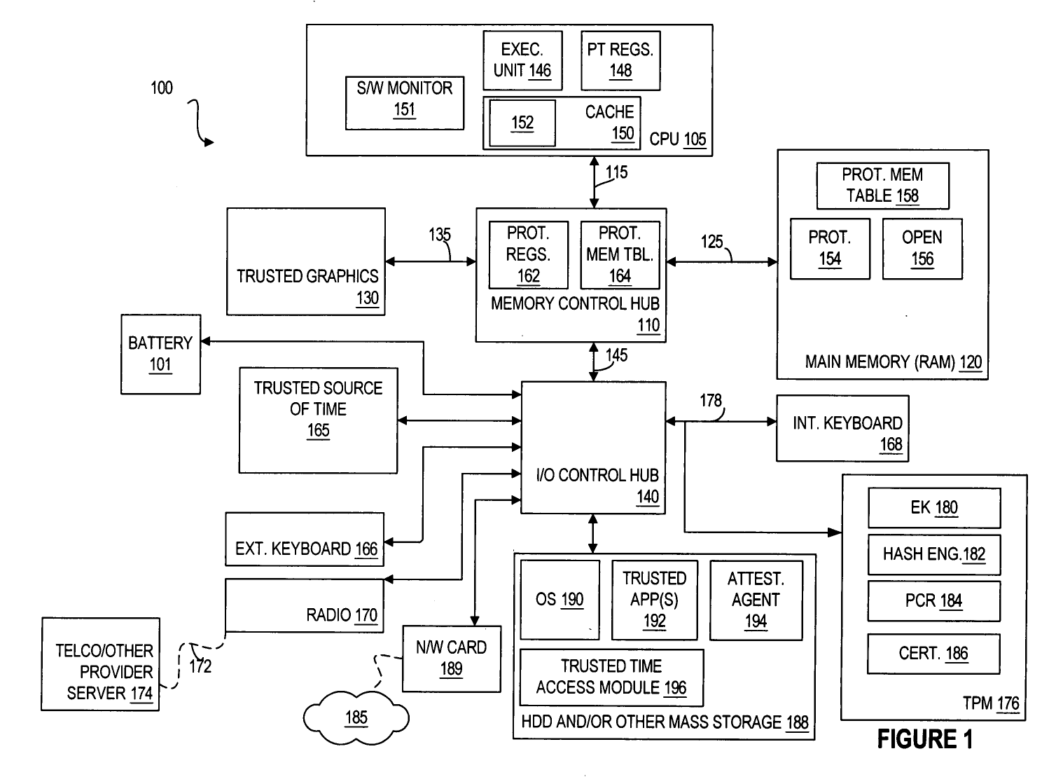

The chipset may be a logic circuit to provide an interface between the processor 105, the memory 120, and other devices. For one embodiment, the chipset is implemented as one or more individual integrated circuits as shown in FIG. 1, but for other embodiments, the chipset may be implemented as a portion of a larger integrated circuit or it may be implemented as parts of multiple other integrated circuits. Further, other capabilities, such as graphics control capabilities, may be provided within the chipset. Although individually labeled herein as a memory controller and I/O controller, these labels should not be read as a limitation on how the chipset features may be physically implemented.

The processor 105 of one embodiment may be an Intel architecture microprocessor that implements a technology, such as Intel Corporation's LaGrande technology (also referred to herein as LT), that provides for protected execution along with other security-oriented features. Some details of LaGrande technology may currently be found, for example, at http://www.extremetech.com/article2/0,3973,1274197,00.asp. For other embodiments, the CPU 105 may be another type of processor such as, for example, an embedded processor, a digital signal processor, a microprocessor from a different source, having a different architecture or implementing a different security technology, etc. and/or more than one processor may be included. The processor 105 may include an execution unit 146, page table (PT) registers 148, one or more on-chip and/or off-chip cache memories 150 and a software monitor 151.

All or part of the cache memory 150 may include, or be convertible to, protected memory 152. Protected memory, as described above, is a memory with sufficient protections to, in most cases, prevent access to it by an unauthorized device (e.g., any device other than the associated processor 105) while activated as a protected memory. In the illustrated embodiment, the cache memory 150 may have various features to permit its selective isolation as a protected memory. The protected memory 152 may alternatively or additionally be external to and separate from the cache memory 150 for some embodiments, but still associated with the processor 105.

PT registers 148 may be used to implement a table to identify which memory pages are to be accessible only by trusted code and which memory pages are not to be so protected.

The trusted software (S/W) monitor 151 may monitor and control the overall protected operating environment once the protected operating environment has been established. The software monitor may alternatively be provided on the memory controller 110 or elsewhere in the system 100. In a particular embodiment, the trusted S/W monitor 151 may be located in a protected memory such as the memory 152 such that it is itself protected from unauthorized alterations.

The processor 105 may further be capable of executing instructions that provide for protected execution of trusted software. For example, the execution unit 146 may be capable of executing instructions to isolate open and protected partitions in on-chip (e.g. the cache memory 150) and off-chip memory (e.g. the main memory 120) and to control software access to protected memory.

The MCH 110 of one embodiment may provide for additional memory protection to block device accesses (e.g. DMA accesses)) to protected memory pages. For some embodiments, this additional memory protection may operate in parallel to the execution of the above-described instruction(s) by the CPU 105 to control software access to both on and off-chip protected memory to mitigate software attacks.

For example, the MCH 110 may include protected registers 162, and a protected memory table 164. In one embodiment, the protected registers 162 are registers that are writable only by commands that may only be initiated by trusted microcode (not shown) in the processor 105. Protected microcode is microcode whose execution may only be initiated by authorized instruction(s) and/or by hardware that is not controllable by unauthorized devices.

The protected registers 162 may hold data that identifies the locations of, and/or controls access to, the protected memory table 164 and the trusted S/W monitor 151. The protected registers 162 may include a register to enable or disable the use of the protected memory table 164 so that DMA protections may be activated before entering a protected operating environment and deactivated after leaving the protected operating environment, for example. Protected registers 162 may also include a writable register to identify the location of the protected memory table 164, so that the location does not have to be hardwired into the chipset.

For one embodiment, the protected registers 162 may further store the temporary location of the trusted S/W monitor 151 before it is placed into protected locations of memory, so that it may be located for transfer when the protected operating environment provided by the system 100 is initialized. For one embodiment, the protected registers 162 may include an execution start address of the trusted S/W monitor 151 after its transfer into memory, so that execution may be transferred to the trusted S/W monitor 151 after initialization of the protected operating environment.

The protected memory table 164 may define the memory blocks (where a memory block is a range of contiguously addressable memory locations) in the memory 120 that are to be inaccessible for direct memory access (DMA) transfers and/or by other untrusted sources. Since all accesses associated with the memory 120 are managed by the MCH 110, the MCH 110 may check the protected memory table 164 before permitting any DMA or other untrusted transfer to take place.

In one embodiment, the protected memory table 164 may be implemented as a table of bits, with each bit corresponding to a particular memory block in the memory 120. In a particular operation, the memory blocks protected from DMA transfers by the protected memory table 164 may be the same memory blocks restricted to protected processing by the PT registers 148 in the processor 105.

The main memory 120 may include both protected 154 and open 156 memory pages or partitions. Access to protected pages or partitions 154 in memory 120 is limited by the CPU 105 and/or the MCH 110 to specific trusted software and/or components as described in more detail herein, while access to open pages or partitions in the memory 120 is according to conventional techniques.

As illustrated in FIG. 1, the main memory 120 may further include a protected memory table 158. In one embodiment, the protected memory table is implemented in the MCH 110 as the protected memory table 164 as described above and the protected memory table 158 may be eliminated. In another embodiment, the protected memory table is implemented as the protected memory table 158 in the memory 120 and the protected memory table 164 may be eliminated. The protected memory table may also be implemented in other ways not shown. Regardless of physical location, the purpose and basic operation of the protected memory table may be substantially as described.

A trusted source of time 165 may also be coupled to the I/O control hub 140 or another component of the system 100. The trusted source of time 165 may be provided by an independent clock chip such as, for example, the CK408 spread spectrum differential system clock generator available from Philips Semiconductors of Eindhoven, The Netherlands. Other clock chips may instead be used to provide the trusted source of time 165.

Alternatively, the trusted source of time 165 may be a composite mechanism that may include one or more of the following elements: a GPS (global positioning system) receiver, a module to synchronize time over a network and one or more radio frequency (RF) transceivers dedicated to time synchronization. The manner in which a GPS receiver may be used as a time transfer mechanism is well-known and well-documented in readily available literature. Similarly, the network-based protocols for time synchronization are well-known. Other methods that use proprietary RF transceiver technology to synchronize time are also prevalent.

Examples of approaches to providing a trusted source of time for some embodiments may also be found in co-pending U.S. patent applications Ser. No. 10/334,267 entitled “Trusted Real Time Clock,” attorney docket number 42.P15183, and/or Ser. No. 10/334,954 entitled, “Trusted System Clock,” attorney docket number 42.P15184, both filed Dec. 31, 2002 and assigned to the assignee of the present invention.

For some embodiments, the trusted source of time 165 may be selected to meet predetermined minimum requirements on the accuracy of time it reports. In whatever form the source of time is provided, it is considered a trusted source of time because it is coupled to the I/O controller 140 or other element of the system 100 via a trusted path to mitigate software and/or hardware attacks as described herein in reference to other components and associated trusted paths. The trusted path between the source of time 165 and other components of the system 100 may be provided as described in one or more of the copending U.S. patent applications referenced above, or copending U.S. patent application Ser. No. 10/609,828 entitled, “Trusted Input for Mobile Platforms Transactions,” filed Jun. 20, 2003, Attorney Docket Number 42.P16205, to D. Poisner and assigned to the assignee of the present invention. By providing a trusted path, the mechanism used to measure, maintain and report time is tamper-resistant from a malicious agent trying to affect any related processes. A function of the trusted source of time 165 is to provide a reliable estimate of time when requested.

With continuing reference to FIG. 1, where the computing system 100 is a mobile computing system, such as, for example, a laptop or notebook computer, the ICH 140 may be coupled to both an external keyboard 166 and an internal keyboard 168. For other types of systems and/or for some mobile systems, only one of the external and internal keyboards may be provided. A secure or trusted path between the external 166 and/or internal keyboard 168 and trusted software may be provided to protect the trusted partition of the system 100 from untrusted inputs and/or other types of attacks. For one embodiment, this secure path may be in accordance with, for example, copending patent application Ser. No. 10/609,828 entitled, “Trusted Input for Mobile Platforms Transactions,” filed Jun. 30, 2003 and assigned to the assignee of the present invention.

A radio 170, which may be part of a wireless local or wide area network (WLAN or WWAN) or other wireless networking card, may also be coupled to the ICH 140 to provide for wireless connectivity over a wireless network 172, which may be operated/serviced by a telephone company (telco) or other service provider and/or may be used by a service provider to provide services to the computing system 100. For such an example, a server operated by the service provider, such as the server 174, may couple to the computing system 100 over the wireless network 172 via the radio 170. The network 172 may be a GSM/GPRS (Global System for Mobile communications/General Packet Radio Services) network, for example. Other types of wireless network protocols such as, for example, CDMA (Code Division Multiple Access), PHS (Personal Handyphone System), 3G (Third generation services) networks, etc. are also within the scope of various embodiments.

A hardware token such as a Trusted Platform Module (TPM) 176, which may be in accordance with a currently available or future revision of the TPM specification, currently version 1.1, available from the Trusted Computer Platform Alliance (TCPA) and version 1.2 of the Trusted Computing Group (TCG), may also be coupled to the ICH 140 over, for example, a low pin count (LPC) bus 178. The TPM 176 may be provided to protect data related to creating and maintaining a protected operating environment and is associated directly with the computing platform 100. In other words, the hardware token 176 is not moved from system to system.

For one embodiment, the hardware token 176 is a discrete hardware device that may be implemented, for example, using an integrated circuit. For another embodiment, the hardware token 176 may be virtualized, i.e. it may not be provided by a physically separate hardware chip on the motherboard, but may instead be integrated into another chip, or the capabilities associated with a TPM or other hardware token as described herein, may be implemented in another manner.

The TPM 176 of one embodiment may include one or more non-volatile storage areas to store an endorsement key (EK) 180 and/or other keys associated with the system 100. The EK may be a public/private key-pair. The private component of the key-pair is generated within the TPM 176 and is not exposed outside the TPM 176. The EK is unique to the particular TPM and, therefore, to the particular platform to which the TPM is coupled.

The TPM 176 of one embodiment may further include a hash engine 182 to compute hash values of small pieces of data, platform configuration register(s) (PCRs) 184 to store platform-specific information, and certificates 186. The certificates 186 may include, for example, one or more of an endorsement certificate, which contains the public key of the EK and provides attestation that the TPM 176 is genuine and the EK is protected, a platform certificate, which may be provided by the platform vendor to provide attestation that the security components of the platform are genuine and a conformance certificate, which may be provided by the platform vendor or an evaluation lab to provide attestation by an accredited party as to the security properties of the platform. Other elements such as, for example, a cryptographic engine (not shown), digital signatures (not shown), a hardware random number generator (not shown), monotonic counters (not shown), etc. may also be included in the hardware token 176 for various embodiments.

Further, while the trusted source of time 165 is shown in FIG. 1 as being a standalone component/element, for some embodiments, the trusted source of time may be integrated with the hardware token or with another component of the computing system 100.

A hard disk drive (HDD) and associated storage media and/or other mass storage device 188, such as a compact disc drive and associated media, may also be coupled to the ICH 140. While only one mass storage reference block 188 is shown in FIG. 1, it will be appreciated that multiple mass storage devices of various types may be used to implement the mass storage device (media) 188. Further, additional or alternative storage devices may be accessible by the computing system 100 over the network 172, or over another network 185 that may be accessed via a network card, modem or other wired communications device 189, for example.

The computing system 100 may further run an operating system 190 that provides for open and protected partitions for software execution. For one embodiment, the operating system 190 may be provided by Microsoft Corporation of Redmond, Wash., and may incorporate Microsoft's Next-Generation Secure Computing Base (NGSCB) technology. The operating system 190 is shown as being stored on the mass storage device 188, but all or part of the operating system 190 may be stored in another storage device on or accessible by the computing system 100.

The computer-accessible storage medium 188 of one embodiment may further store one or more trusted applications 192, an attestation agent 194 and/or a trusted time access module (TTAM) 196. The attestation agent 194 and/or the trusted time access module 196 may be provided as part of the operating system 190 software, as standalone modules, or as part of another software modules such as application software.

The attestation agent 194, as described in more detail below, is responsible for associating a time estimate provided by the trusted source of time 165 with a particular process, thread, or event executing in a trusted environment on the platform 100, where the process/thread/event may associated with a trusted application requesting the time stamp. The attestation agent 194 provides proof that the trusted process and trusted time estimate are both generated by the same trusted platform within the intended context.

The trusted time access module 196, as described in more detail below, is responsive to a request from a trusted application for a trusted time stamp to read a time estimate, call the attestation agent and forward a signed response (or time stamp) to the requesting application.

It will be appreciated that the various modules 192, 194 and/or 196 may be stored in another data store associated with or accessible by the computing system 100.

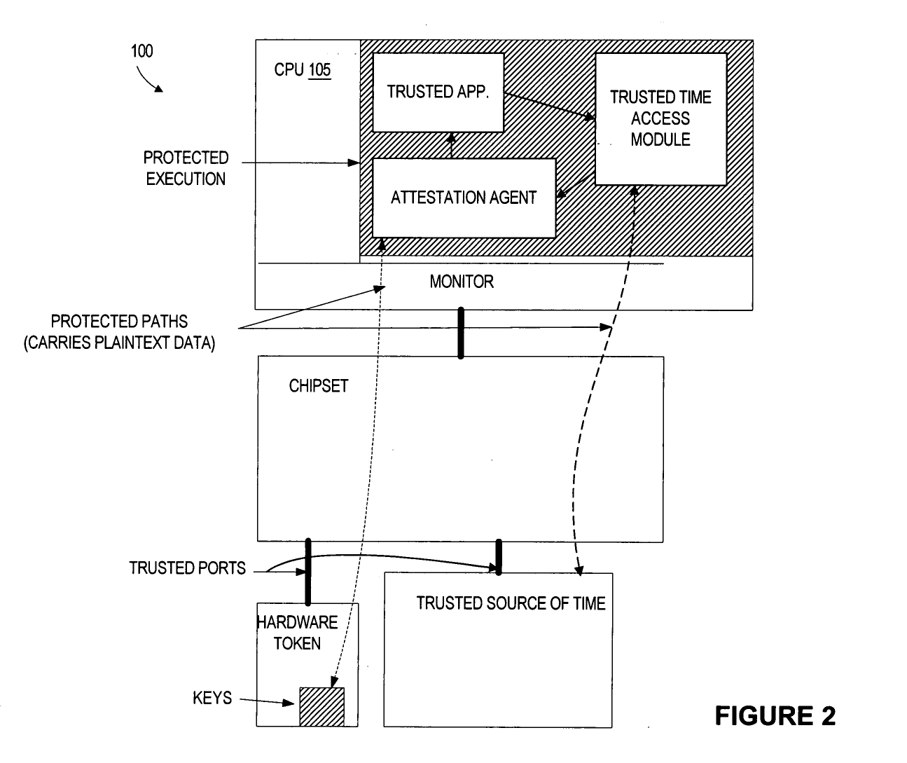

FIG. 2 shows, at a high level, various trusted paths and partitions that may be provided in the computing system 100 of one exemplary embodiment when a trusted execution environment has been established and various software modules as shown are being executed by the processor 105. The trusted areas are shaded in FIG. 2 and some of the trusted paths and ports are identified. For other embodiments, it will be appreciated that different trusted paths and partitions may be provided and/or all the trusted paths and partitions shown in FIG. 2 may not necessarily be provided.

Figur 3 is a high-level conceptual drawing showing various partitions that may be provided by the operating system 190 of FIG. 1 when a secure operating environment has been established for one embodiment. An open or standard partition 305 provided by the operating system 190 runs the main operating system, drivers, applications 310 and associated APIs. A protected partition 315 includes a protected operating system kernel 316 and trusted applets or applications such as the trusted applications 192. Associated API(s) may also be included. Security features such as those described herein may be accessible to software developers through various APIs, for example.

While some elements of a specific platform architecture and a specific, associated operating system are described herein, it will be appreciated that other platform architectures and/or operating system architectures that provide for protected storage, protected execution and protected input/output as described herein may also be used for various embodiments.

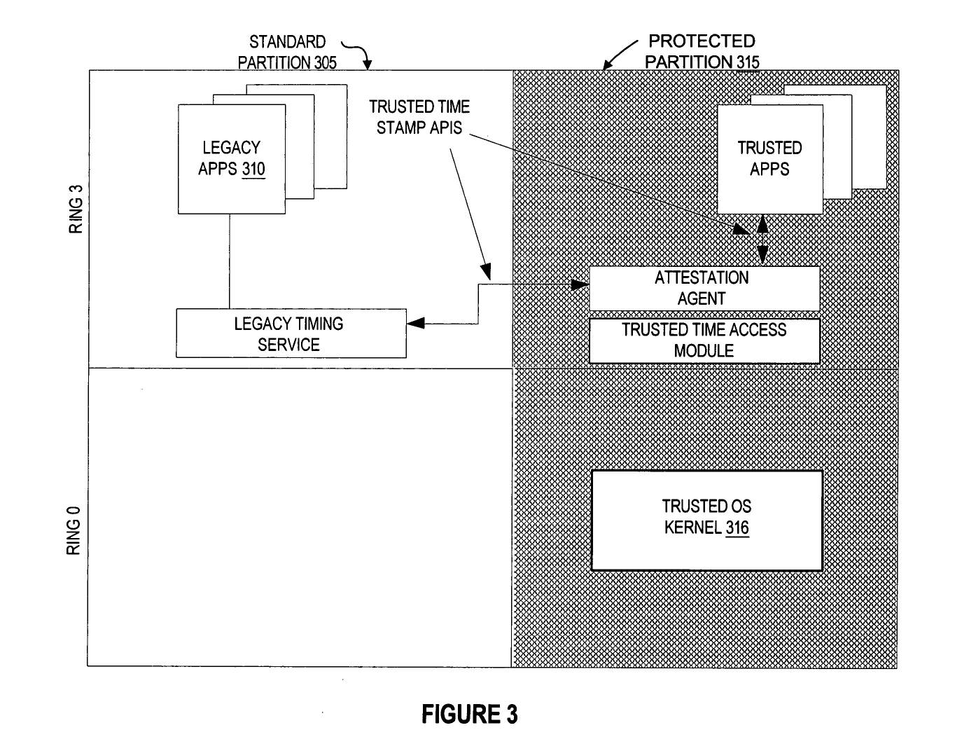

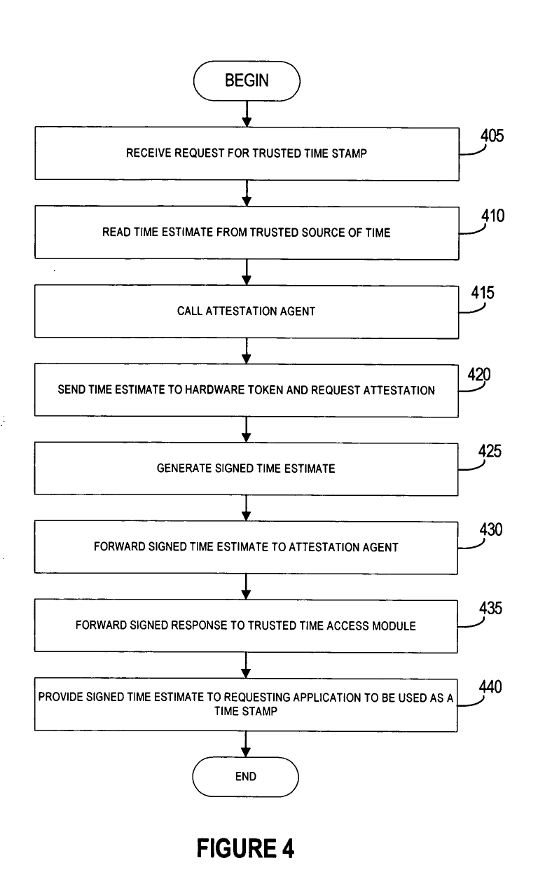

For one embodiment, as mentioned above, trusted time stamp capabilities are provided on an open platform, such as the computing platform 100 of FIG. 1. A method of one embodiment for providing a trusted time stamp is described in reference to FIGS. 1, 2, 3 and 4. FIG. 4 is a flowchart showing an exemplary method of one embodiment for providing a trusted time stamp on an open platform. In describing the method of FIG. 4, reference may be made to FIGS. 1, 2 and/or 3 for purposes of illustration. It will be appreciated, however, that the software and/or hardware modules referenced may not necessarily be used to perform the described actions for all embodiments.

At block 405, a trusted application running in a trusted environment, such as the trusted environment that may be established on the computing system 100 of FIG. 1, for example, initiates a request for a trusted time stamp. Examples of applications that may advantageously use the trusted time stamp capabilities of various embodiments may include, for example, online banking or purchasing applications, applications that authorize use of sensitive resources, online voting applications, time keeping applications for competitive sports or gaming, data logging and synchronization applications, general purpose secure remote control (e.g. locking/unlocking home/car, etc.), electronic cash transactions, etc.

At block 410, a time estimate may then be read from the trusted source of time over a trusted path. For the computing system 100, for example, the trusted time access module 196 may receive the request for the time stamp and access the trusted source of time 165 to read the time estimate.

An attestation process may then be performed. This may involve calling an attestation agent at block 415. For the computing system 100, the trusted time access module 196 may call the attestation agent 194.

In its simplest form, attestation may be accomplished by digitally signing a digest value of the piece of data that is to be attested. For a more complex implementation, the digest value may be synthesized by combining together various other elements in addition to the original data to be attested. Examples of such elements may include, but not be limited to, hash values of platform hardware/software configuration, other credentials, one-time nonce values, etc.

An exemplary attestation approach is described with continuing reference to FIG. 4. It will be appreciated, however, that other attestation methods may be used for other embodiments. At block 420, the attestation agent may send the time estimate, and possibly other application-specific identifiers, to the TPM or other hardware token 176 with a request for attestation.

At block 425, the TPM 176 may sign the time estimate and concatenate a hash of certain platform configuration parameters and/or other credentials that uniquely identify the platform. For the computing system 100, for example, the hashing engine 182 may perform the hash using platform configuration parameters stored in the platform configuration register(s) 184 and/or credentials generated using the EK (endorsement key) or another key 180.

At block 430, the signed response including associated credentials and/or other information are sent back to the attestation agent 194 and at block 435, the attestation agent 194 forwards the signed response and associated credentials and/or other information back to the trusted time access module 196. For one embodiment, the other information may include information that associates the signed response with the requesting application, thread, event or transaction.

For embodiments for which the trusted source of time 165 is integrated with the TPM or other hardware token 176, the attestation mechanism/module may partially or completely execute within the integrated device.

At block 440, the trusted time access module forwards the signed response to the trusted application at which point the signed response is used to provide the requested trusted time stamp. The trusted application may then associate the trusted time stamp with the particular transaction or event that it intends to timestamp.

It will be appreciated that for some embodiments, not all of the above actions may be performed, the actions may be performed in a different order and/or additional actions may be included.

Using the above-described approach of various embodiments, it may be possible to use a computing platform as a general purpose secure remote control or other type of device that may be used for a variety of different applications.

Thus, various embodiments of a method and apparatus for managing privacy and disclosure of computing system location information are described. In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method comprising:
receiving a request for a trusted time stamp;
reading a time estimate from a trusted source of time;
performing an attestation process to provide proof that the time estimate is to be trusted; and
providing the attested time estimate in response to the request.

2. The method of claim 1 wherein
receiving the request for the trusted time stamp includes receiving the request from a trusted application executing in a trusted partition on a computing system.

3. The method of claim 1 wherein
reading a time estimate from a trusted source of time includes reading a time estimate from one of an independent clock chip and a composite mechanism, the composite mechanism including at least one of a global positioning system (GPS) receiver, a module to synchronize time using a network, and a radio frequency transceiver dedicated to time synchronization.

4. The method of claim 1 wherein performing the attestation process includes providing the time estimate to a hardware token.

5. The method of claim 4 wherein providing the time estimate to a hardware token includes providing the time estimate to a Trusted Platform Module (TPM).

6. The method of claim 5 wherein performing the attestation process includes the TPM signing the time estimate together with a hash of platform configuration parameters.

7. An apparatus comprising:
a trusted time access module to receive a request for a trusted time stamp, request a time estimate from a trusted source of time, and request attestation of the time estimate; and
an attestation module to provide attestation including signing the time estimate, the attestation module further to return the signed time estimate to the trusted time access module.

8. The apparatus of claim 7 wherein the trusted time access module is further to return the signed time estimate as the requested time stamp to an application that made the request.

9. The apparatus of claim 7 wherein the attestation provided by the attestation agent includes providing the time estimate to a hardware token to sign the time estimate.

10. The apparatus of claim 9 wherein the hardware token is a Trusted Platform Module (TPM).

11. The apparatus of claim 7 wherein the hardware token and the trusted source of time are integrated.

12. A system comprising:
a bus to communicate information;
a processor coupled to the bus;
an antenna coupled to the bus; and
a data store to store information that, when executed by the system, causes the system to
receive a request for a trusted time stamp;
read a time estimate from a trusted source of time;
perform an attestation process to provide proof that the time estimate is to be trusted; and
provide the attested time estimate in response to the request.

13. The system of claim 12 wherein the processor in cooperation with an operating system, provides for protected execution in a protected partition.

14. The system of claim 13 wherein the processor implements LaGrande technology from Intel Corporation.

15. The system of claim 13 wherein the request is received from a trusted application executing in the protected partition.

16. The system of claim 12 further comprising
the trusted source of time, the trusted source of time comprising one of an independent clock chip and a composite mechanism, the composite mechanism including at least one of a global positioning system (GPS) receiver, a module to synchronize time using a network, and a radio frequency transceiver dedicated to time synchronization.

17. The system of claim 16 wherein the trusted source of time is coupled to the system via a trusted path.

18. The system of claim 17 further comprising a hardware token integrated with the trusted source of time.

19. The system of claim 17 further comprising a hardware token coupled to the bus, the hardware token to be accessed during the attestation process.

20. The system of claim 19 wherein the hardware token is a Trusted Platform Module.

21. A method comprising:
receiving a request for a trusted time stamp from a trusted application executing in a protected partition;
requesting a time estimate from a trusted source of time;
receiving the requested time estimate from the trusted source of time;
performing an attestation process on the time estimate received from the trusted source of time, the attestation process producing a signed time estimate; and
providing the signed time estimate to the trusted application as the trusted time stamp.

22. The method of claim 21 wherein performing the attestation process includes providing the time estimate received from the trusted source of time to a hardware token.

23. The method of claim 22 wherein performing the attestation process includes providing the time estimate received from the trusted source of time to a Trusted Platform Module.

24. The method of claim 22 wherein performing the attestation process includes performing at least part of the attestation process in an integrated module including a Trusted Platform Module and the trusted source of time.

25. A computer-accessible storage medium comprising information, that when accessed by a computing system, causes the computing system to:
receive a request for a trusted time stamp;
read a time estimate from a trusted source of time;
perform an attestation process to provide proof that the time estimate is to be trusted; and
provide the attested time estimate in response to the request.

26. The computer-accessible storage medium of claim 25 wherein
receiving the request for the trusted time stamp includes receiving the request from a trusted application executing in a trusted partition on the computing system.

27. The computer-accessible storage medium of claim 25 wherein
reading a time estimate from a trusted source of time includes reading a time estimate from one of an independent clock chip and a composite mechanism, the composite mechanism including at least one of a global positioning system (GPS) receiver, a module to synchronize time using a network, and a radio frequency transceiver dedicated to time synchronization.

28. The computer-accessible storage medium of claim 25 wherein performing the attestation process includes providing the time estimate to a hardware token.

29. The computer-accessible storage medium of claim 28 wherein providing the time estimate to a hardware token includes providing the time estimate to a Trusted Platform Module (TPM).

30. The computer-accessible storage medium of claim 29 wherein performing the attestation process includes the TPM signing the time estimate together with a hash of platform configuration parameters.
